(19) United States
(12) Patent Application Publication
(10) Pub. No.: US 2012/0140982 A1
(43) Pub. Date: Jun. 7, 2012

(54) IMAGE SEARCH APPARATUS AND IMAGE SEARCH METHOD

(75) Inventors: Hiroshi Sukegawa, Yokohama-shi (JP); Osamu Yamaguchi, Yokohama-shi (JP)

(73) Assignee: KABUSHIKI KAISHA TOSHIBA, Tokyo (JP)

(21) Appl. No.: 13/232,245

(22) Filed: Sep. 14, 2011

(30) Foreign Application Priority Data
Dec. 6, 2010 (JP) 2010-271508

(51) Int. Cl. G06K 9/00

(52) U.S. Cl. 382/103

(57) ABSTRACT

According to one embodiment, an image search apparatus includes, an image input module which is input with an image, an event detection module which detects events from the input image input by the image input module, and determines levels, depending on types of the detected events, an event controlling module which retains the events detected by the event detection module, for each of the levels, and an output module which outputs the events retained by the event controlling module, for each of the levels.

### CROSS-REFERENCE TO RELATED APPLICATIONS

This application is based upon and claims the benefit of priority from prior Japanese Patent Application No. 2010-271508, filed Dec. 6, 2010, the entire contents of which are incorporated herein by reference.

### FIELD

Embodiments described herein relate generally to an image search apparatus and an image search method.

### BACKGROUND

Developments are made in technology for searching for a desired image from monitor images obtained by a plurality of cameras installed at a plurality of locations. Such technology is to search for a desired image from among images directly input from cameras or images accumulated in a recording apparatus.

For example, there is technology of detecting an image which images some change or images a human figure. An observer specifies a desired image by monitoring detected images. However, if a large number of images imaging changes or human figures are detected, a visual check of the detected images requires much labor.

For an easy visual check of images, there is technology of searching for a similar image by pointing out attribute information for a face image. For example, a face image including a specified feature can is searched for from a database by specifying a feature of a face of a human figure to search for, as a search condition.

Further, there is technology of narrowing face images by using attributes (in text form) preliminarily appended to a database. For example, a high-speed search is achieved by performing a search by using a name, a member ID, or registration year/month/date, in addition to a face image. Further, recognition dictionaries are narrowed by using attribute information (height, weight, gender, age, etc.) other than main biometric information such as a face.

However, when an image which matches with attribute information is searched for, there is a problem that accuracy degrades since time points of imaging are considered by neither dictionaries' side nor inputting side.

When narrowing is performed by using age information in text form, the narrowing cannot be achieved unless attribute information (in text form) is preliminarily attached to search targets.

The present invention hence provides an image search apparatus and an image search method capable of more efficiently performing an image search.

### BRIEF DESCRIPTION OF THE DRAWINGS

FIG. 1 is an exemplary diagram showing for explaining an image search apparatus according to an embodiment;

FIG. 2 is an exemplary diagram showing for explaining the image search apparatus according to the embodiment;

FIG. 3 is an exemplary diagram showing for explaining the image search apparatus according to the embodiment;

FIG. 4 is an exemplary diagram showing for explaining the image search apparatus according to the embodiment;

FIG. 5 is an exemplary table showing for explaining the image search apparatus according to the embodiment;

FIG. 6 is an exemplary graph showing for explaining the image search apparatus according to the embodiment;

FIG. 7 is an exemplary diagram showing for explaining an image search apparatus according to an another embodiment;

FIG. 8 is an exemplary diagram showing for explaining the image search apparatus according to the another embodiment;

FIG. 9 is an exemplary diagram showing for explaining the image search apparatus according to the another embodiment;

FIG. 10 is an exemplary diagram showing for explaining the image search apparatus according to the another embodiment; and

FIG. 11 is an exemplary diagram showing for explaining the image search apparatus according to the another embodiment.

### DETAILED DESCRIPTION

In general, according to one embodiment, an image search apparatus comprises; an image input module which is input with an image, an event detection module which detects events from the input image input by the image input module, and determines levels, depending on types of the detected events, an event controlling module which retains the events detected by the event detection module, for each of the levels, and an output module which outputs the events retained by the event controlling module, for each of the levels.

Hereinafter, an image search apparatus and an image search method according to one embodiment will be specifically described.

### First Embodiment

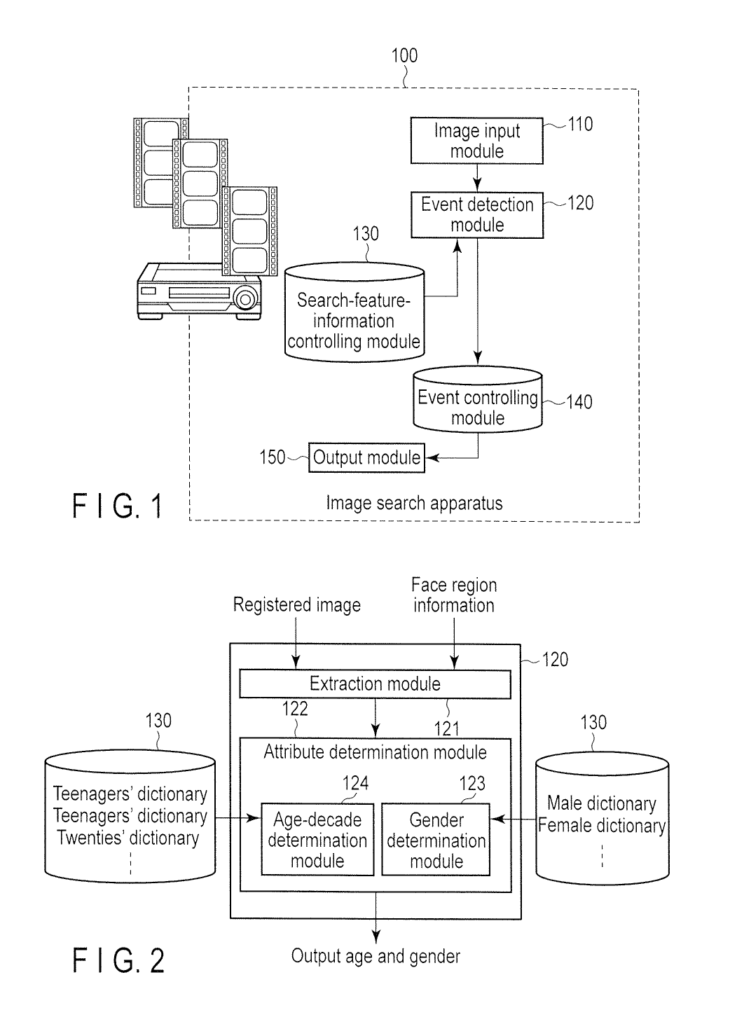

FIG. 1 is an exemplary diagram showing for explaining an image search apparatus 100 according to the one embodiment.

As shown in FIG. 1, the image search apparatus 100 comprises an image input module 110, an event detection module 120, a search-feature-information controlling unit module 130, an event controlling module 140, and an output module 150. The image search apparatus 100 may comprise an operation module which receives an operational input from users.

The image search apparatus 100 extracts scenes which image a specific human figure from input images (image sequence or photographs) such as monitor images. The image search apparatus 100 extracts events depending on reliability degrees indicating how reliably a human figure is imaged. In this manner, the image search apparatus 100 assigns levels to scenes including the extracted events, respectively for the reliability degrees. By controlling a list of the extracted events linked with images, the image search apparatus 100 can easily output scenes in which a desired human figure exists.

In this manner, the image search apparatus 100 can search for the same human figure as imaged in a face photo currently in hand. The video search apparatus 100 can also search for relevant images when an accident or crime happens. Further, the image search apparatus 100 can search for relevant scenes or events among images from an installed security camera.

The image input module 110 is an input means to which images are input from a camera or a storage which stores images.

The event detection module 120 detects events such as a moving region, a personal region, face region, personal attribute information, or personal identification information. The event detection module 120 sequentially obtains information (frame information) indicating positions of frames including the detected events in a video image.

A search-feature-information controlling module 130 stores personal information and information used for attribute determination.

An event controlling module 140 links input images, detected events, and frame information to one another. The output module 150 outputs a result controlled by the event controlling module 140.

Modules of the image search apparatus 100 will now be described in order below.

The image input module 110 inputs a face image of a target human figure to image. The image input module 110 comprises, for example, an industrial television (ITV) camera. The ITV camera digitizes optical information received through a lens, by an A/D converter, and outputs the information as image data. In this manner, the image input module 110 can output image data to the event detection module 120.

The image input module 110 may alternatively be configured to comprise a recording apparatus such as a digital video recorder (DVR), which records images, or an input terminal which is input with images recorded on a recording medium. Specifically, the image input module 110 may have any configuration insofar as the configuration can obtain digitized image data.

A search target needs only to be, finally, digital image data including a face image. An image file imaged by a digital still camera may be loaded through a medium, or even a digital image scanned from a paper medium or a photograph is available. In this case, a scene of searching a large amount of stored still images for a corresponding image is cited as an application example.

The event detection module 120 detects an image supplied from the image input module 110 or an event to be detected based on a plurality of images. The event detection module 120 also detects an index indicating a frame (e.g., a frame number) in which an event has been detected. For example, when images to be input are a plurality of still images, the event detection module 120 may detect file names of the still images as frame information.

The event detection module 120 detects, as events, a scene where a region which moves with a predetermined size or more exists, a scene where a human figure exists, a scene where a face of a human figure is detected, a scene where a face of a human figure is detected and a person corresponding to a specific attribute exists, and a scene where a face of a human figure is detected and a specific person exists. However, events which are detected by the event detection module 120 are not limited to those described above. The event detection module 120 may be configured to detect an event in any way insofar as the event indicates that a human figure exists.

The event detection module 120 detects a scene which may image a human figure, as an event. The event detection module 120 adds levels respectively to scenes in order from a scene from which the greatest amount of information relevant to a human figure can be obtained.

Specifically, the event detection module 120 assigns “level 1” as the lowest level to each scene where a region which moves over a predetermined size or more exists. The event detection module 120 assigns “level 2” to each scene where a human figure exists. The event detection module 120 assigns “level 3” to each scene where a human figure's face is detected. The event detection module 120 assigns “level 4” to each scene where a human figure's face is detected and a human figure corresponding to a specific attribute exists. Further, the event detection module 120 assigns “level 5” as the highest level to each scene where a human figure's face is detected and a specific person exists.

The event detection module 120 detects a region which moves over a predetermined size or more, in a method described below. The event detection module 120 detects a scene where a region which moves over a predetermined size or more exists, based on a method disclosed in Japanese Patent No. P3486229, P3490196, or P3567114.

Specifically, the event detection module 120 stores, for preliminary study, a distribution of luminance in a background image, and compares an image supplied from the image input module 110 with the prestored luminance distribution. As a result of comparison, the event detection module 120 determines that an “object not forming part of a background exists” in any region of the image which does not match with the luminance distribution.

In the present embodiment, general versatility can be improved by employing a method capable of correctly detecting an “object not forming part of a background” even from an image including a background where a periodical change appears like trembling of leaves.

The event detection module 120 extracts pixels where a predetermined or greater change in luminance occurred in the detected moving region, and transforms the pixels into a binary image expressed by “change=1” and “no change=0”. The event detection module 120 divides each set of pixels each of which is expressed by “1” by means of labeling, and calculates a size of a moving region, based on a size of a circumscribed rectangle for each of the sets of pixels, or based on a number of moving pixels included in each of the sets of pixels. If the calculated size is larger than a preset reference size, the event detection module 120 determines “changed” and extracts the image.

If the moving region is extremely large, the event detection module 120 determines that pixel values have changed because the sun has gone behind a cloud and it has suddenly become dark or because a near illumination has turned on, or from any other casual reason. Therefore, the event detection module 120 can correctly extract a scene where a moving object such as a human figure exists.

The event detection module 120 can also correctly extract a scene where a moving object such as a human figure exists, by setting an upper limit to a size to be determined as a moving region. For example, the event detection module 120 can more accurately extract a scene where a human figure exists, by setting thresholds for upper and lower limits to an assumed size of a distribution of a human being.

The event detection module 120 can detect a scene where a human figure exists, based on a method described below. For example, the event detection module 120 can detect a scene where a human figure exists by using technology of detecting a region of the whole of a human figure. The technology of detecting a region of the whole of a human figure is described for example, Document 1 (Watanabe et al., “Co-occurrence Histograms of Oriented Gradients for Pedestrian Detection, In Proceedings of the 3rd Pacific-Rim Symposium on Image and Video Technology” (PSIVT2009), pp. 37-47.)

In this case, the event detection module 120 obtains how a distribution of luminance gradient information appears when a human figure exists, by using co-occurrence at a plurality of local regions. If a human figure exists, an upper half region of the human figure can be calculated as rectangle information.

If a human figure exists in an input image, the event detection module 120 detects a frame thereof as an event. According to this method, the event detection module 120 can detect a scene where a human figure exists even when a face of the human figure is not imaged in the image or if resolution is insufficient to recognize a face.

Based on a method described below, the event detection module 120 detects a scene where a face of a human figure is detected. The event detection module 120 calculates a correlation value with moving a prepared template within an input image. The event detection module 120 specifies, as a face region, a region where a highest correlation value is calculated. In this manner, the event detection module 120 can detect a scene where a face of a human figure is imaged.

Alternatively, the event detection module 120 may be configured to detect a face region by using an eigen space method or a subspace method. The event detection module 120 detects a position of a facial portion such as an eye or a nose from an image of a detected face region. The event detection module 120 can detect facial portions according to a method described in, for example, Document 2 (Kazuhiro Fukui and Osamu Yamaguchi, “Facial Feature Point Extraction Method Based on Combination of Shape Extraction and Pattern Matching”, Transactions of the Institute of Electronics, Information and Communication Engineers (D), vol. J80-D-II, No. 8, pp 2170-2177 (1997))

When the event detection module 120 detects one face region (facial feature) from one image, the event detection module 120 obtains a correlation value with respect to a template for the whole image, and outputs a position and a size which maximize the correlation value. When a plurality of facial features are obtained from one image, the event detection module 120 obtains a local maximum value of the correlation value for the while image, and narrows candidate positions of a face in consideration of overlapping within one image. Further, the event detection module 120 can finally simultaneously detect a plurality of facial features in consideration of relationships (chronological transition) with past images which have been sequentially input.

Alternatively, the event detection module 120 may be configured to prestore facial patterns of human figures wearing a mask, sunglasses, and a headgear, as templates in order that a face region can be detected even if a human figure wears a mask, sun-glasses, or a headgear.

If the event detection module 120 cannot detect all of facial feature points when the event detection module 120 detects facial feature points, the event detection module 120 performs a processing, based on evaluation values for part of facial feature points. Specifically, if an evaluation value for part of facial feature points is not smaller than a preset reference value, the event detection module 120 can estimate remaining feature points from feature points which have been detected by using a two-dimensional or three-dimensional facial model.

Even when any feature point can not be detected at all, the event detection module 120 can detect a position of a whole face and can estimate a facial feature point from the position of the whole face, by preliminarily studying a pattern of a whole face.

If a plurality of faces exist in an image, the event detection module 120 may give an instruction about which face to set as a search target, by a search condition setting means or an output means. Further, the event detection module 120 may be configured to automatically select and output search targets in an order of indices indicating face likelihood obtained through the processing described above.

If one identical human figure is imaged throughout sequential frames, it is more adequate to treat the frames as “one event which images one identical human figure” than to control the frames as respectively different events, in many cases.

Hence, the event detection module 120 calculates probabilities, based on statistical information indicating which of sequential frames a human figure who normally walks moves to, and selects a combination which maximizes the probability. The event detection module 120 can thereby associate the combination with an event to issue. In this manner, the event detection module 120 can recognize, as one event, a scene where an identical human figure is imaged throughout a plurality of frames.

When a frame rate is high, the event detection module 120 associates personal regions or face regions with one another between frames by using, for example, an optical flow. Accordingly, the event detection module 120 can recognize, as one event, a scene where an identical human figure is imaged throughout a plurality of frames.

Further, the event detection module 120 can select a “best shot” from a plurality of frames (a group of associated images). The best shot is most suitable for visually checking a human figure.

Among frames included in a detected event, the event detection module 120 selects, as the best shot, a frame having the highest value which takes at least one or more indices into consideration, from among a frame which includes the largest face region, a frame in which a face of a human being is directed in a direction closest to the front direction, a frame which has the greatest contrast of an image in a face region, and a frame which has the greatest similarity to a pattern indicating face likelihood.

Alternatively, the event detection module 120 may be configured to select, as the best shot, an easy-to-see image for human eyes or an image suitable for a recognition processing. A selection criterion for selecting such a best shot may be freely set based on user's discretion.

The event detection module 120 detects a scene where a human figure corresponding to a specific attribute exists, based on a method described below. The event detection module 120 calculates feature information for specifying attribute information of a human figure by using information of a face region detected by the processing described above.

Attribute information described in the present embodiment has been described as including the five types of age, sex, glasses type, mask type, and headgear type. However, the event detection module 120 may be configured to use other attribute information. For example, the event detection module 120 may be configured to use, as attribute information, a race, wearing glasses or not (information of 1 or 0), wearing a mask or not (information of 1 or 0), wearing a headgear or not (information of 1 or 0), a facial accessory (pierce, earring, etc.), a wear, a face look, an obesity index, a wealth index, etc. The event detection module 120 can use any feature as an attribute by studying a pattern in advance for each attribute by using an attribute determination method described later.

The event detection module 120 extracts a facial feature from an image in a face region. For example, the event detection module 120 can calculate the facial feature by using the subspace method.

When an attribute of a human figure is determined by comparing a facial feature with attribute information, there is a case that a calculation method for calculating a facial feature differs for each attribute. Hence, the event detection module 120 may be configured to calculate a facial feature by using a calculation method depending on attribute information to be compared with.

For example, when comparison is performed with attribute information such as an age or a gender, the event detection module 120 can more accurately determine an attribute by applying an adequate pre-processing for each of the age and gender.

Usually, every human figure has a face which more wrinkles as an age of the human figure increases. Therefore, the event detection module 120 can determine an attribute (age decade) of a human figure with high accuracy, by synthesizing a line-segment emphasis filter which emphasizes wrinkles, on an image of a face region.

The event detection module 120 synthesizes a filter which emphasizes a frequency component to emphasize a portion specific to a gender (such as a beard), on an image of a face region, or synthesizes a filter which emphasizes skeletal information, on an image of a face region. In this manner, the event detection module 120 can more accurately determine an attribute (gender) of a person.

Further, the event detection module 120 specifies a position of an eye, an outer canthus, or an inner canthus from a facial portion obtained by a face detection processing. Therefore, the event detection module 120 can obtain feature information concerning glasses by cutting out an image around two eyes and by treating the cut image as a calculation target for a subspace.

The event detection module 120 specifies, for example, positions of a mouth and a nose from positional information of facial portions, which is obtained by the face detection processing. Therefore, the event detection module 120 can obtain feature information concerning a mask, by cutting out an image around the specified positions of the mouth and nose and by treating the cut image as a calculation target for a subspace.

The event detection module 120 specifies positions of eyes and eyeblows from positional information of facial portions obtained by the face detection processing. Therefore, the event detection module 120 can specify an upper end of a skin region of a face. Further, the event detection module 120 can obtain feature information concerning a headgear, by cutting out an image of a top region of a specified face and by treating the cut image as a calculation target for a subspace.

As described above, the event detection module 120 can extract feature information by specifying glasses, a mask, and a hat from a position of a face. Specifically, the event detection module 120 can extract feature information from any attribute insofar as the attribute exists at a position which is estimable from a position of a face.

An algorithm which directly detects an object which a human figure puts on has generally been put into practical use. The event detection module 120 may be configured to extract feature information by using such a method.

Unless a human figure wears glasses, a mask, or a headgear, the event detection module 120 extracts facial skin information directly as feature information. Therefore, different feature information is extracted individually for each of attributes such as glasses, a mask, and sunglasses. Specifically, the event detection module 120 need not mandatory extract feature information by particularly classifying attributes such as glasses, a mask, and sunglasses.

The event detection module 120 may be configured to separately extract feature information indicating nothing put on if a human figure wears neither glasses, a mask, nor a hat.

After calculating the feature information for determining an attribute, the event detection module 120 further compares the feature information with attribute information stored by the search-feature-information controlling module 130 described later. The event detection module 120 thereby determines an attribute such as a gender, an age decade, glasses, a mask, and a hat for a human figure of an input face image. The event detection module 120 sets, as an attribute to be used for detecting an event, at least one of an age, a gender, wearing glasses or not, a glasses type, wearing a mask or not, a mask type, wearing a headgear or not, a headgear type, a beard, a mole, a wrinkle, an injury, a hair color, a wear color, a wear shape, a headgear, an ornament, an accessory near a face, a face look, a wealth degree, and a race.

The event detection module 120 outputs the determined attribute to the event detection module 120. Specifically, as shown in FIG. 2, the event detection module 120 comprises an extraction module 121 and an attribute determination module 122. The extraction module 121 extracts feature information for a predetermined region in a registered image (input image), as described above. For example, when face region information indicating a face region and an input image are input, the extraction module 121 then calculates feature information for the region indicated by the face region information in the input image.

The attribute determination module 122 determines an attribute of a human figure in the input image, based on feature information extracted by the extraction module 121 and attribute information prestored in the search-feature-information controlling module 130. The attribute determination module 122 determines an attribute of the human figure in the input image, by calculating a similarity between feature information extracted by the extraction module 121 and attribute information prestored in the search-feature-information controlling module 130.

The attribute determination module 122 comprises, for example, a gender determination module 123 and an age-decade determination module 124. The attribute determination module 122 may further comprise a determination module for determining a further attribute. For example, the attribute determination module 122 may comprise a determination module which determines an attribute such as glasses, a mask, or a headgear.

For example, the search-feature-information controlling module 130 preliminarily retains male attribute information and female attribute information. The gender determination module 123 calculates similarities, based on the male attribute information and female attribute information retained by the search-feature-information controlling module 130, and the feature information extracted by the extraction module 121. The gender determination module 123 outputs attribute information for which a greater similarity has been calculated, as a result of an attribute determination for an input image.

For example, as described in Jpn. Pat. Appln. KOKAI Publication No. 2010-044439, the gender determination module 123 uses a feature amount by retaining an occurrence frequency of a local gradient feature of a face as statistical information. Specifically, the gender determination module 123 determines two classes such as maleness and femaleness, by selecting a gradient feature for which maleness or femaleness can be most identified from the statistical information, and by calculating a discriminator which identifies the feature through studies.

If there are attributes of three classes or more in place of two classes, as in age estimation, the search-feature-information controlling module 130 preliminarily retains dictionaries of average facial features (attribute information) for the respective classes (age decades in this case). The age-decade determination module 124 calculates a similarity between attribute information for each age decade, which is retained in the search-feature-information controlling module 130, and feature information extracted by the extraction module 121. The age-decade determination module 124 determines an age decade of a human figure in an input image, based on the attribute information used for calculating the highest similarity.

Technology for estimating an age decade at much higher accuracy will be a method described below, which uses a two-class discriminator as described above.

At first, in order to estimate ages, the search-feature-information controlling module 130 preliminarily retains a face image for each of ages which are desired to identify. For example, to determine an age decade group of ages from 10 to 60, the search-feature-information controlling module 130 preliminarily retains a face image for ages smaller than 10 and not smaller than 60. In this case, as the number of face images retained by the search-feature-information controlling module 130 increases, age decades can be determined more accurately. Further, the search-feature-information controlling module 130 can widen determinable ages by preliminarily retaining face images for wider age decades.

Next, the search-feature-information controlling module 130 prepares a discriminator for determining “whether an age decade is greater or smaller than a reference age”. The search-feature-information controlling module 130 can make the event detection module 120 perform a two-class determination by using linear discriminate analysis.

The event detection module 120 and search-feature-information controlling module 130 may be configured to employ a method such as a support vector machine. The support vector machine will be hereinafter referred to as an SVM. According to the SVM, a boundary condition for discriminating two classes can be set, and whether a distance is within a set distance from a boundary or not can be calculated. Therefore, the event detection module 120 and search-feature-information controlling module 130 can discriminate face images which belong to ages greater than a reference age N and face images which belong to ages smaller than the reference age N.

For example, where the reference age is 30, the search-feature-information controlling module 130 preliminarily retains a group of images for determining whether 30 is exceeded or not. For example, the search-feature-information controlling module 130 is input with images including images for the age 30 or higher, as images for a positive class of “30 or higher”. The search-feature-information controlling module 130 is also input with images for a negative class of “smaller than 30”. The search-feature-information controlling module 130 performs SVM studies based on the input images.

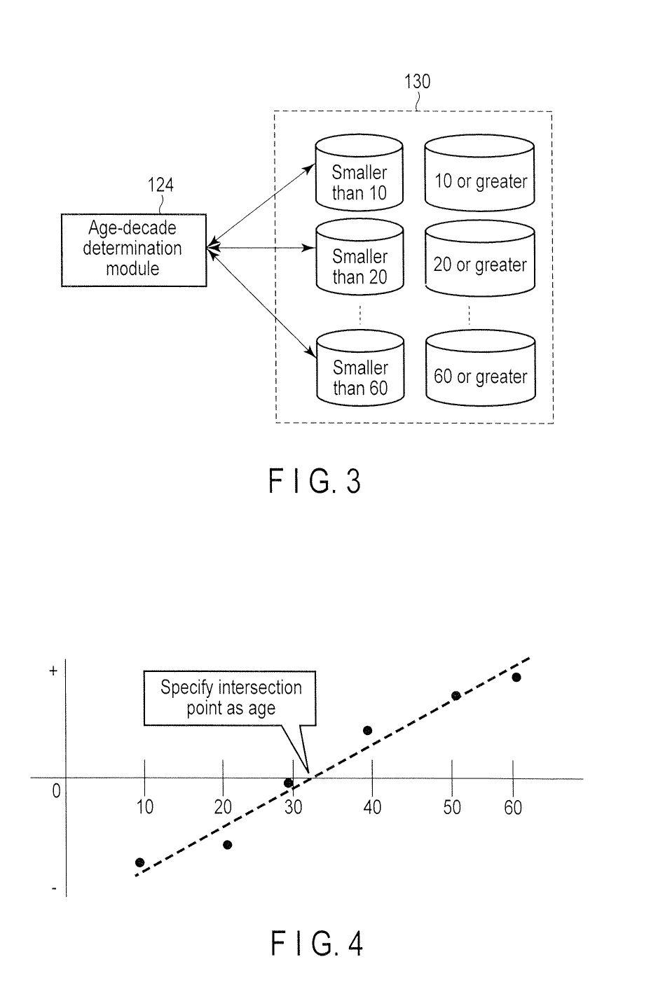

By the method described above, the search-feature-information controlling module 130 creates dictionaries, with reference ages shifted from 10 to 60. In this manner, for example, as shown in FIG. 3, the search-feature-information controlling module 130 creates dictionaries for age decade determination of “10 or greater”, “smaller than 10”, “20 or greater”, “smaller than 20”, . . . , and “60 or greater”, “smaller than 60”. The age-decade determination module 124 determines an age decade for a human figure in an input image, based on a plurality of dictionaries for age decade determination which are stored by the search-feature-information controlling module 130, and based on the input image.

The search-feature-information controlling module 130 classifies images for age decade determination, which have been prepared by shifting the reference ages from 10 to 60, into two classes relative to a reference age. In this manner, the search-feature-information controlling module 130 can prepare a SVM study machine in accordance with the number of reference ages. In the present embodiment, the search-feature-information controlling module 130 prepares six study machines for ages from 10 to 60.

The search-feature-information controlling module 130 “returns an index of a plus value when an age greater than the reference age is input” by studying a class of “age X or greater” as a “positive” class. An index indicating whether an age decade is greater or lower than the reference age can be obtained, by performing this determination processing with shifting the reference ages from 10 to 60. Among indices thus output, an index which is closest to zero is closest to an age to be output.

FIG. 4 shows a method for estimating an age. An age-decade determination module 124 in the event detection module 120 calculates an output value of the SVM for each reference age. Further, the age-decade determination module 124 plots output values along the vertical axis representing output values and along the horizontal axis representing reference ages. Based on the plot, the age-decade determination module 124 can specify an age of a human figure in an input image.

For example, the age-decade determination module 124 selects a plot whose output value is closest to zero. In the example shown in FIG. 4, the reference age 30 results in the output value closest to zero. In this case, the age-decade determination module 124 outputs “thirties” as an attribute of a human figure in an input image. When the plot unstably fluctuates up and down, the age-decade determination module 124 can stably determine an age decade by calculating an average change relative to adjacent reference ages.

For example, the age-decade determination module 124 may be configured to calculate an approximation function, based on a plurality of plots adjacent to one another, and to specify a value on the horizontal axis as an estimated age if an output value of the calculated approximation function is 0. In an example shown in FIG. 4, the age-decade determination module 124 specifies an intersection point by calculating a linear approximation function, based on plots, and can specify an age of approximately 33 from the specified intersection point.

Further, the age-decade determination module 124 may be configured to calculate an approximation function based on all plots in place of a subset (e.g., plots covering three adjacent reference ages). In this case, an approximation function with less approximation errors can be calculated.

Alternatively, the age-decade determination module 124 may be configured to determine a class by a value obtained from a predetermined transform function.

Further, the event detection module 120 detects a scene where a specific person exists, based on a method described below. At first, the event detection module 120 calculates feature information for specifying attribute information of a human figure by using information of a face region detected by the processing as described above. In this case, the search-feature-information controlling module 130 comprises a dictionary for specifying a person. This dictionary comprises feature information calculated from a face image of a person to specify.

The event detection module 120 cuts a face region into a constant size and a constant shape, based on detected positions of parts of a face, and uses grayscale information thereof as a feature amount. Here, the event detection module 120 uses grayscale values of a region of m×n pixels directly as feature information, and m×n dimensional information as a feature vector.

The event detection module 120 performs a processing by employing the subspace method, based on feature information extracted from an input image and feature information of a person retained by the search-feature-information controlling module 130. Specifically, the event detection module 120 calculates a similarity between feature vectors by performing normalization to set lengths of vectors each to 1 and by calculating an inner product, according to a simple similarity method.

Alternatively, the event detection module 120 may apply a method of creating an image in which a direction or condition of a face is intentionally moved, by using a model, to face image information of one image. According to the processing described above, the event detection module 120 can obtain a feature of a face from an image.

The event detection module 120 can recognize a human figure at higher accuracy, based on an image sequence including a plurality of images obtained chronologically sequentially from one identical human figure. For example, the event detection module 120 may be configured to employ a mutual subspace method described in Document 3 (Kazuhiro Fukui, Osamu Yamaguchi, and Kenichi Maeda: “Face Recognition System using Temporal Image Sequence”, IEICE technical report PRMU, vol 97, No. 113, pp 17-24 (1997))

In this case, the event detection module 120 cuts out an image of m×n pixels from an image sequence, as in the feature extraction processing described above, obtains a correlation matrix based on the cut data, and obtains orthonormal vectors by KL expansion. Therefore, the event detection module 120 can calculate a subspace indicating a facial feature obtained from the sequential images.

According to a calculation method for a subspace, a correlation matrix (or covariance matrix) of feature vectors is calculated, and orthonormal vectors (eigen vectors) are calculated by K-L expansion thereof. Accordingly, a subspace is calculated. The subspace is expressed by selecting k eigen vectors corresponding to an eigen value, in an order from one having the greatest eigen value, and by using a set of the eigen vectors. In the present embodiment, a matrix Φ of eigen vectors is obtained by obtaining a correlation matrix Cd from feature vectors, and by diagonalizing the matrix with the correlation matrix Cd=Φd Λd Φd T. This information is a subspace indicating a facial feature of a human figure who is currently a recognition target.

Feature information such as a subspace which is output in a method as described above is taken as feature information of a person for a face detected from an input image. The event detection module 120 performs a processing of performing a calculation to indicate similarities to facial feature information in the search-feature-information controlling module 130 which preliminarily registers a plurality of faces, and of returning results in order from one having the highest similarity.

At this time, as results of the search processing, human figures controlled in the search-feature-information controlling module 130 to identify persons, IDs, and indices indicating similarities as calculation results are returned in order from one having the highest similarity. In addition to the results, information controlled for each of persons by the search-feature-information controlling module 130 may be returned together. However, since association with identification IDs is available, additional information need not be used in the search processing.

An index indicating a similarity, a similarity between subspaces controlled as facial feature information is used. A calculation method thereof may be a subspace method, a multiple similarity method, or any other method. In the method, both of recognition data prestored in registration information and input data are expressed as subspaces calculated from a plurality of images, and an “angle” between two subspaces is defined as a similarity.

Here, an input subspace is referred to as an input means subspace. The event detection module 120 also obtains a correlation matrix Cin for an input data column, and is diagonalized with the matrix with Cin=ΦinΛinΦinT, thereby to obtain eigen vectors Φin. The event detection module 120 obtains a subspace similarity (0.0 to 1.0) for a subspace expressed by two eigen vectors Φin and Φd. The event detection module 120 uses this similarity as a similarity for recognizing a person.

The event detection module 120 may be configured to identify a person by projecting a plurality of face images, which are known to belong to one identical human figure, together to a subspace. In this case, accuracy of personal identification can be improved.

The search-feature-information controlling module 130 retains a variety of information used in a processing for detecting various events by the event detection module 120. As described above, the search-feature-information controlling module 130 retains information required for determining persons, and attributes of human figures.

The search-feature-information controlling module 130 retains, for example, facial feature information for each of the persons, and feature information (attribute information) for each of the attributes. Further, the search-feature-information controlling module 130 can retain attribute information associated with each identical human figure.

The search-feature-information controlling module 130 retains, as facial feature information and attribute information, a variety of feature information calculated in the same method as the event detection module 120. For example, the search-feature-information controlling module 130 retains m×n feature vectors, a subspace, or a correlation matrix immediately before KL expansion is performed.

Feature information for specifying persons cannot be prepared in advance in many cases. Therefore, the configuration may be arranged so as to detect human figures from photographs or image sequences input to the image search apparatus 100, calculate feature information based on images of detected human figures, and store the calculated feature information into the search-feature-information controlling module 130. In this case, the search-feature-information controlling module 130 stores, with associating the feature information, facial images, identification IDs, and names with one another, wherein the names are input through an unillustrated operation input module.

The search-feature-information controlling module 130 may be configured to store different additional information or attribute information associated with feature information, based on preset text information.

The event controlling module 140 retains information concerning an event detected by the event detection module 120. For example, the event controlling module 140 stores input image information directly just as the image information is input or down-converted. If image information is input from an apparatus such as DVR, the event controlling module 140 stores link information to a corresponding image. In this manner, the event controlling module 140 can easily search a scene which is instructed about when playback of an arbitrary scene is instructed about. Accordingly, the image search apparatus 100 can play the image search apparatus 100.

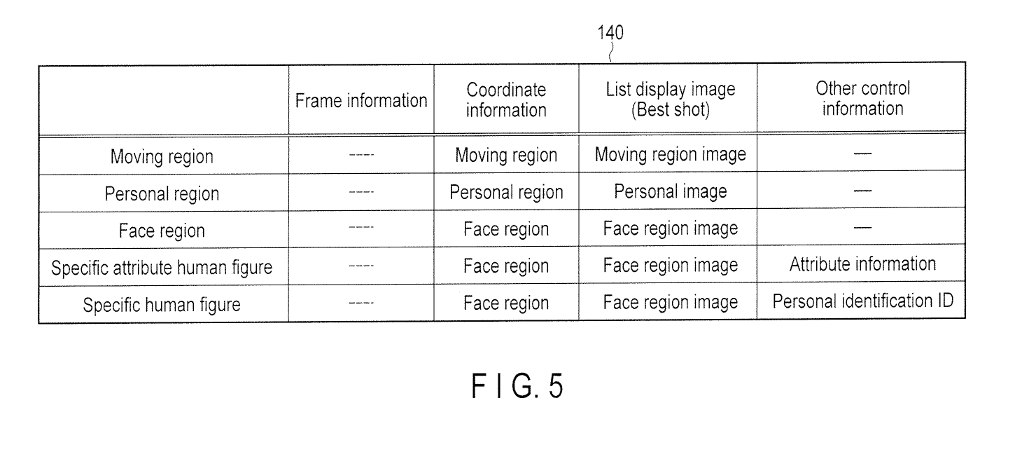

FIG. 5 is a table showing for explaining an example of information stored by the event controlling module 140.

As shown in FIG. 5, the event controlling module 140 retains types of events (equivalent to levels described above) detected by the event detection module 120, information (coordinate information) indicating coordinates at which detected objects are imaged, attribute information, identification information for identifying persons, and frame information indicating frames in images, with the types and foregoing information associated with one another.

The event controlling module 140 controls, as a group, a plurality of frames throughout which one identical human figure is sequentially imaged. In this case, the event controlling module 140 selects and retains a best shot image as a representative image. For example, when a face region has been detected, the event controlling module 140 retains a face image from which the face region can be known, as a best shot.

Alternatively, when a personal region has been detected, the event controlling module 140 retains an image of a personal region as a best shot. In this case, the event controlling module 140 selects, as a best shot, an image in which a personal region is imaged to be largest or an image in which a human figure is determined to face in a direction closest to the front direction due to bilateral symmetry.

When a moving region has been detected, for example, the event controlling module 140 selects, as a best shot, an image in which a moving amount is the greatest or an image which shows a move but looks stable since a moving amount thereof is small.

As has been described above, the event controlling module 140 classifies events detected by the event detection module 120 into levels depending on “human likelihood”. Specifically, the event controlling module 140 assigns “level 1” as the lowest level to a scene where a region which moves over a predetermined size or more exists. The event controlling module 140 assigns “level 2” to a scene where a human figure exists. The event controlling module 140 assigns “level 3” to a scene where a face of a human figure is detected. The event controlling module 140 assigns “level 4” to a scene where a face of a human figure is detected and a person corresponding to a specific attribute exists. Further, the event controlling module 140 assigns “level 5” as the highest level to a scene where a face of a human figure is detected and a specific person exists.

As the level is closer to 1, failures in detecting a “scene where a human figure exists” decrease. However, sensitive detections occur more often, and accuracy in narrowing to a specific person decreases. As the level is closer to 5, an event which is more narrowed to a specific person is output. On the other side, failures in detection increase.

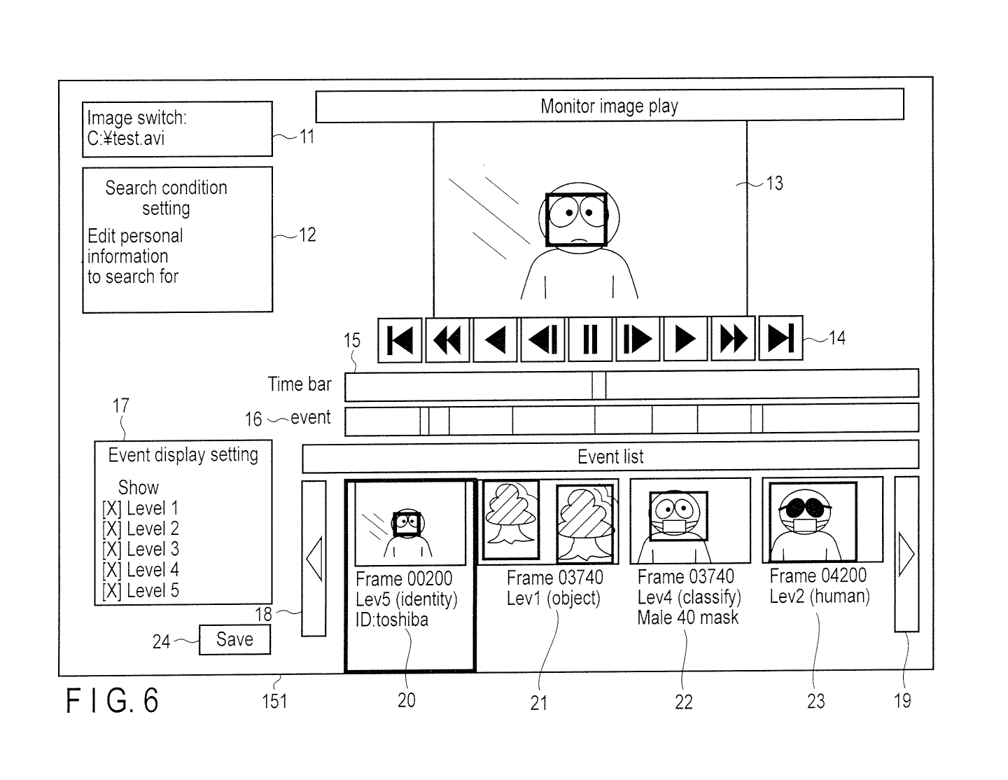

FIG. 6 is a diagram showing for explaining an example of a screen displayed by the image search apparatus 100.

The output module 150 outputs an output screen 151 as shown in FIG. 6, based on information stored by the event controlling module 140.

The output screen 151 output from the output module 150 comprises an image switch button 11, a detection setting button 12, a playback screen 13, control buttons 14, a time bar 15, event marks 16, and an event-display setting button 17.

The image switch button 11 is to switch an image as a processing target. This embodiment will now be described with reference to an example of reading an image file. In this case, the image switch button 11 shows a file name of a read image file. As described above, an image to be processed by the present apparatus may be directly input from a camera or may be a list of still images in a folder.

The detection setting button 12 is to make a setting for detection from an image as a target. For example, to perform the level 5 (personal identification), the detection setting button 12 is operated. In this case, the detection setting button 12 shows a list of persons as search targets. The displayed list of persons may be configured to allow the persons to be deleted or edited or to allow a new search target to be added.

The playback screen 13 is a screen which plays an image as a target. A playback processing for an image is controlled by the control buttons 14. For example, the control button 14 comprises “skip to previous event”, “reverse high-speed play”, “reverse play”, “frame-by-frame reverse”, “pause”, “frame-by-frame advance”, “play”, “high-speed play”, and “skip to next event” in this order from the left side in FIG. 6. A further button for another function may be added or any useless buttons may be deleted from the control buttons 14.

The time bar 15 indicates a playback position relative to a whole image length. The time bar 15 comprises a slider which indicates a current playback position. When the slider is operated, the image search apparatus 100 performs a processing to change the playback position.

The event marks 16 marks positions of detected events. Positions of the event marks 16 correspond to playback positions on the time bar 15. When the “skip to previous event” or “skip to next event” of the control buttons 14 is operated, the image search apparatus 100 skips to a position of an event existing before or after the slider of the time bar 15.

The event-display setting button 17 comprises check boxes shown for levels 1 to 5. Events corresponding to checked levels are marked as the event marks 16. Specifically, the user can make useless events undisplayed by operating the event-display setting button 17.

Further, the output module 150 comprises buttons 18 and 19, thumbnails 20 to 23, and a save button 24.

The thumbnails 20 to 23 form a displayed list of events. The thumbnails 20 to 23 respectively show best shot images for events, frame information (frame numbers), event levels, and additional information concerning the events. The image search apparatus 100 may be configured to show images of detected regions as the thumbnails 20 to 23 if a personal region or a face region is detected for each event. The thumbnails 20 to 23 show events close to corresponding positions on the slider of the time bar 15.

When the button 18 or 19 is operated, the image search apparatus 100 switches one of the thumbnails 20 to 23 to another. For example, when the button 18 is operated, the image search apparatus 100 then displays a thumbnail concerning an event existing before a currently displayed event.

Alternatively, when the button 19 is operated, the image search apparatus 100 then displays a thumbnail concerning an event existing after a currently displayed event. A thumbnail corresponding to an event being played on the playback screen 13 is displayed, bordered as shown in FIG. 6.

When any of the displayed thumbnails 20 to 23 is selected by a double click, the image search apparatus 100 skips to a playback position of a selected event and displays a corresponding image on the playback screen 13.

The save button 24 is to store an image or an image sequence of an event. When the save button 24 is selected, the image search apparatus 100 can then store, into an unillustrated storage module, an image of an event corresponding to a selected one of the displayed thumbnails 20 to 23.

If the image search apparatus 100 saves an event as an image, this image to save may be selected and saved from a “face region”, “upper half body region”, “whole body region”, “whole moving region”, and “whole image” in accordance with an operation input. In this case, the image search apparatus 100 may be configured to output a frame number, file name, and text file. The image search apparatus 100 outputs, as a file name for the text file, a file name having a different extension from that of an image file. Further, the image search apparatus 100 may output all relevant information in text form.

When an event is an image sequence of the level 1, the image search apparatus 100 outputs, as an image sequence file, images for a duration throughout which a move continues sequentially. When an event is an image sequence of the level 2, the image search apparatus 100 outputs, as an image sequence file, images corresponding to a range throughout which one identical human figure can be associated throughout a plurality of frames.

The image search apparatus 100 can store the file which is thus output, as an evidence image or video which can be visually checked. Further, the image search apparatus 100 can output the file to a system which performs comparison with preregistered human figure.

As described above, the image search apparatus 100 is input with a monitor camera image or a recorded image, and extracts scenes where human figures are imaged, with the scenes associated with an image sequence. In this case, the image search apparatus 100 assigns levels to extracted events, depending on reliability degrees indicating how reliably the human figures exist. Further, the image search apparatus 100 controls a list of extracted events, linked with images. In this manner, the image search apparatus 100 can output scenes where a human figure desired by the user is imaged.

For example, the image search apparatus 100 allows the user to easily see images of detected human figures by outputting firstly an event of the level 5 and secondly an event of the level 4. Further, the image search apparatus 100 makes the user see events throughout an entire image without fails, by displaying the events, switching the levels in order from 3 to 1.

### Second Embodiment

Hereinafter, the second embodiment will be described. Features of configuration which are common to the first embodiment will be referred to common reference symbols, and detailed descriptions thereof will be omitted.

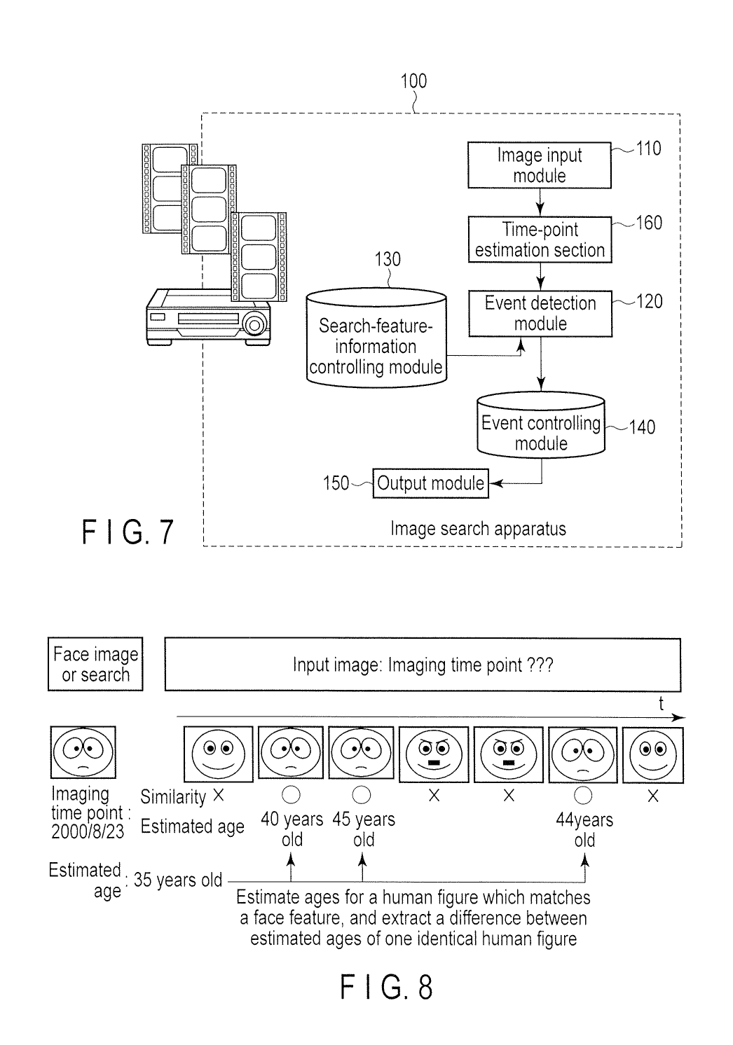

FIG. 7 is a diagram showing for explaining the configuration of an image search apparatus 100 according to the second embodiment. The image search apparatus 100 comprises an image input module 110, an event detection module 120, a search-feature-information controlling module 130, an event controlling module 140, an output module 150, and a time estimation module 160.

The time estimation module 160 estimates a time point of an input image. The time estimation module 160 estimates a time point when the input image was imaged. The time estimation module 160 assigns information (time point information) indicating the estimated time point to the image input to the image input module 110, and outputs the information to the event detection module 120.

Although the image input module 110 has substantially the same configuration as that of the first embodiment, time information indicating an imaging time point of an image is input, according to the present embodiment. For example, when an image is a file, the image input module 110 and the time estimation module 160 can associate frames of the image and time points with each other, based on time stamps and a frame rate of the file.

In digital video recorders (DVR) for monitor cameras, time point information is often graphically embedded in an image. Therefore, the time estimation module 160 can generate time information by recognizing numerical figures expressing time points, which are embedded in the image.

The time estimation module 160 can also obtain a current time point by using time point information obtained from a real time clock which is directly input from a camera.

There is a case that a meta file including information indicating time is added to an image file. In this case, a method is available for providing information indicating a relationship of respective frames with time points, in form of an external meta file as a caption information file, separately from the time estimation module 160. Therefore, time information can be obtained by reading the external meta file.

If time information of an image is not supplied simultaneously together with the image, the image search apparatus 100 prepares, as face images for search, face images which have been respectively preliminarily given imaging time points and ages, or face images for which imaging time points have been known and ages are estimated by using the face images

The time estimation module 160 estimates an imaging time point, based on a method of using EXIF information added to a face image or a time stamp of a file. Alternatively, the time estimation module 160 may be configured to use, as an imaging time point, time information input by an unillustrated operation input.

The image search apparatus 100 calculates similarities between all face images detected from an input image and personal facial feature information for search, which is prestored in the search-feature-information controlling module 130. The image search apparatus 100 performs a processing from an arbitrary position of an image, and estimates an age for a face image for which a predetermined similarity is calculated first. Further, the image search apparatus 100 backwardly calculates an imaging time point of an input image, based an average value or a mode value among differences between age estimation results for the face images for search and age estimation results for the face images for which the predetermined similarity has been calculated.

FIG. 8 shows an example of the time estimation processing. As shown in FIG. 8, ages are preliminarily estimated for the face images for search which are stored in the search-feature-information controlling module 130. In an example shown in FIG. 8, a human figure of a face image for search is estimated to be 35 years old. In this state, the image search apparatus 100 searches for the same human figure as of the face image for search by using facial features from an input image. A method for searching the same human figure is the same as described in the first embodiment.

The image search apparatus 100 calculates similarities between all face images detected from an image and a face image for search. The image search apparatus 100 assigns a similarity “∘” to each face image for which a similarity is calculated to be a preset predetermined value or greater, and assigns a similarity “x” to each face image for which a similarity is calculated to be smaller than the predetermined value.

Based on the face images for which the similarity is calculated to be “∘”, the image search apparatus 100 estimates an age for each of these face images by using the same method as described in the first embodiment. Further, the image search apparatus 100 calculates an average value of the calculated ages, and estimates time point information indicating an imaging time point of an input image, based on a difference between the average value and an age estimated from the face image for search. In this method, the image search apparatus 100 has been described to have a configuration of using an average value of calculated ages. However, the image search apparatus 100 may be configured to use an intermediate value, a mode value, or any other value.

According to the example shown in FIG. 8, calculated ages are 40, 45, and 44. Therefore, an average value thereof is 43. An age difference of 8 years exists to the face image for search.

Specifically, the image search apparatus 100 determines that the input image was imaged between the year 2000 when the face image for search had been imaged and the year 2008 which is eight years after 2000.

If the input image is determined to have been imaged eight years later, for example, the image search apparatus 100 specifies the imaging time point of the input image to be Aug. 23, 2008, including year/month/date, though depending on accuracy of age estimation. Specifically, the image search apparatus 100 can estimate imaging date/time in units of days.

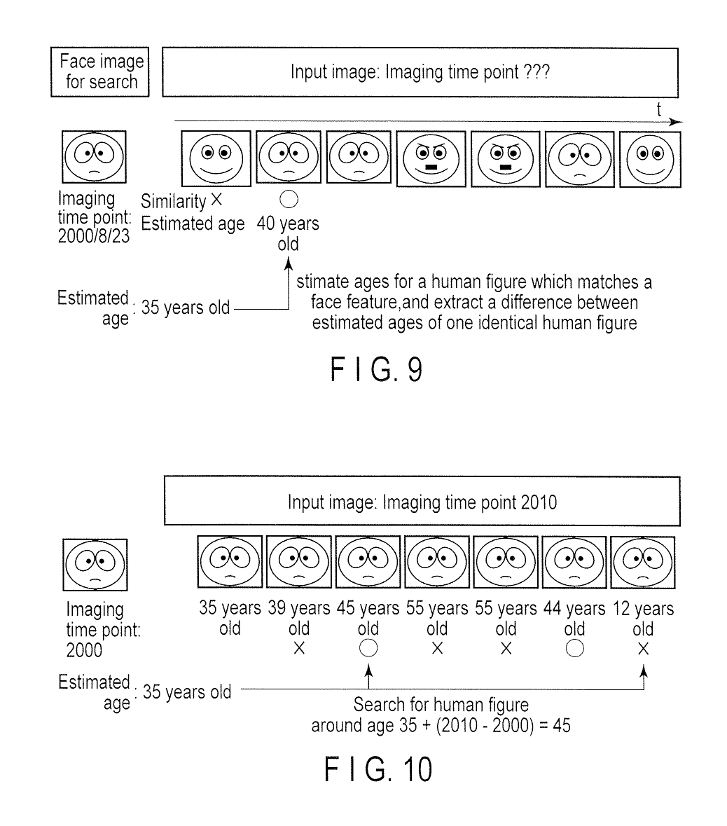

Further, the image search apparatus 100 may be configured to estimate an age, for example, based on a face image detected first, as shown in FIG. 9, and to estimate an imaging time point, based on the estimated age and the age of an image for search. According to this method, the image search apparatus 100 can estimate an imaging time point faster.

The event detection module 120 performs the same processing as the first embodiment. However, in the present embodiment, an imaging time point is added to an image. The event detection module 120 may be configured to associate not only frame information but also an imaging time point with each event detected.

Further, the event detection module 120 may be configured to narrow estimated ages by using a difference between an imaging time point of a face image for search and an imaging time point of an input image, when the event detection module 120 performs a processing of the level 5, i.e., when a scene where a specific person is imaged is detected from an input image.

In this case, as shown in FIG. 10, the event detection module 120 estimates an age at the time when the input image of the human figure to search for was imaged, based on a difference between the imaging time of the face image for search and the imaging time point of the input image. Further, the event detection module 120 estimates ages respectively for human figures in a plurality of events in which the human figures detected from the input image are imaged. The event detection module 120 detects an event in which a human figure close to the age at the time when the input image of the person in the face image for search was imaged.

In the example shown in FIG. 10, the face image for search was imaged in the year 2000, and the human figure in the face image for search is estimated to be 35 years old. Further, the input image is known to be imaged in the year 2010. In this case, the event detection module 120 estimates that an age of the human figure in the face image for search is 35+(2010−2000)=45 at the time point of the input image. The event detection module 120 detects an event in which a human figure who is determined to be close to the estimated age of 45 is imaged.

For example, the event detection module 120 sets, as a target for detecting an event, the age at the time when the input image of the human figure in the face image for search was imaged ±α. In this manner, the image search apparatus 100 can more steadily detect events without fails. The value of α may be arbitrarily set based on a user's operation input or may be preset as a reference value.

As described above, the image search apparatus 100 according to the present embodiment estimates a time point when an input image was imaged, in a processing of the level 5 for detecting a person from an input image. Further, the image search apparatus estimates an age at a time point when an input image of a human figure to search for was imaged. The image search apparatus 100 detects a plurality of scenes in which human figures are imaged, and estimates ages of the human figures who are imaged in the scenes. The image search apparatus 100 can detect a scene where a human figure who is estimated to have an age close to the age of the human figure to search for. As a result, the image search apparatus 100 can detect, at a higher speed, scenes where a specific human figure is imaged.

In the present embodiment, the search-feature-information controlling module 130 further retains time point information indicating a time point when a face image was imaged and information indicating an age at the time point of having imaged the face image, together with feature information extracted from the face image of each human figure. Ages may be either estimated from images or input by the user.

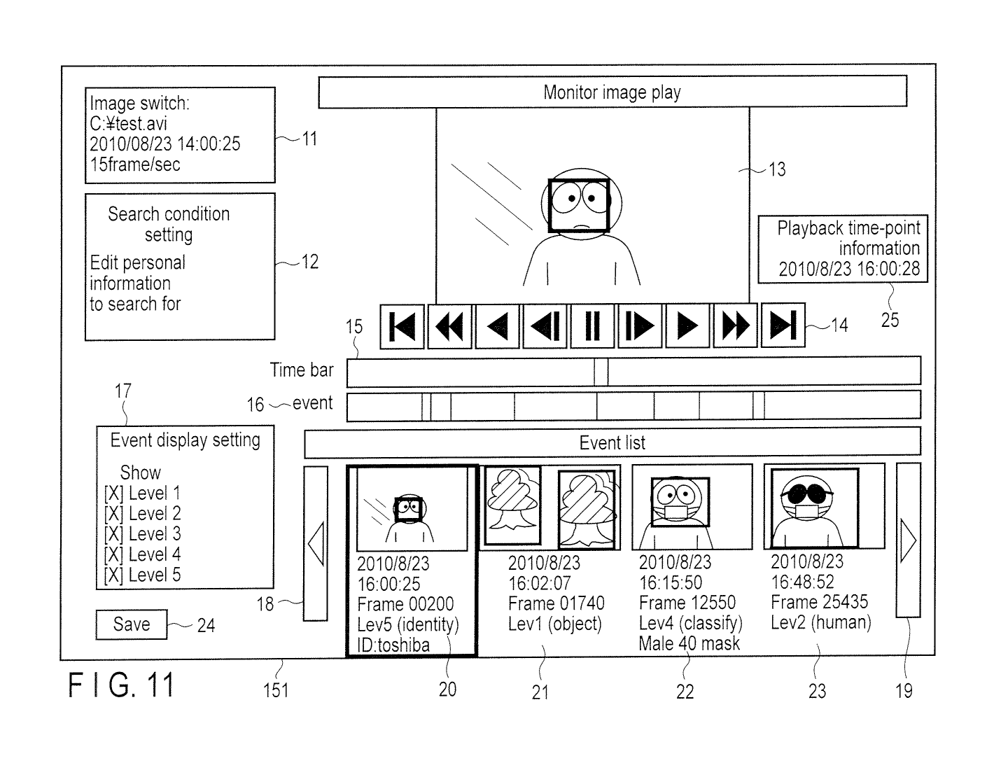

FIG. 11 is a diagram showing for explaining an example of a screen displayed by the image search apparatus 100.

The output module 150 outputs an output screen 151 which comprises time point information 25 indicating a time point of an image in addition to the same content as displayed in the first embodiment. Time point information of the image is thus displayed together. Further, the output screen 151 may be configured to display an age which is estimated based on an image displayed on a playback screen 13. In this manner, the user can recognize an estimated age of a human figure displayed on the playback screen 13.

Functions described in the above embodiment may be constituted not only with use of hardware but also with use of software, for example, by making a computer read a program which describes the functions. Alternatively, the functions each may be constituted by appropriately selecting either software or hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image search apparatus comprising:
an image input module which is input with an image;
an event detection module which detects events from the input image input by the image input module, and determines levels, depending on types of the detected events;
an event controlling module which retains the events detected by the event detection module, for each of the levels; and
an output module which outputs the events retained by the event controlling module, for each of the levels.

2. The image search apparatus of claim 1, wherein the event detection module detects at least one of scenes, as an event, and determines a level for each of the at least one of scenes detected as an event, the scenes being a scene where a moving region exists, a scene where a personal region exists, a scene where a human figure corresponding to a preset attribute exists, and a scene where a preset person exists.

3. The image search apparatus of claim 2, wherein the event detection module sets, as an attribute, at least one of a personal age, a gender, wearing glasses or not, a glasses type, wearing a mask or not, a mask type, wearing a headgear or not, a headgear type, a beard, a mole, a wrinkle, an injury, a hair style, a hair color, a wear color, a wear shape, a headgear, an ornament, an accessory near a face, a face look, a wealth degree, and a race.

4. The image search apparatus of claim 2, wherein the event detection module detects a plurality of sequential frames as an event when the event detection module detects an event from the sequential frames.

5. The image search apparatus of claim 4, wherein the event detection module selects, as a best shot, at least one of a frame in which a largest face region exists, a frame in which a human face faces in a direction closest to a front direction, and a frame in which an image of a face region has greatest contrast, among frames included in the detected event.

6. The image search apparatus of claim 2, wherein the event detection module adds, to an event, frame information indicating a position of a frame from which an event is detected, in the input image.

7. The image search apparatus of claim 6, wherein if a playback screen which displays the input image, and an event mark indicating a position of an event in the input image, which is retained by the event controlling module, and if the event mark is selected, the output module plays the input image from a frame indicated by the frame information added to the event corresponding to the selected event mark

8. The image search apparatus of claim 2, wherein the output module saves, as an image or an image sequence, at least one of a face region, an upper-half body region, a whole body region, a whole moving region, and a whole region, concerning an event retained by the event controlling module.

9. The image search apparatus of claim 2, wherein
the event detection module performs
estimating a time point when the input image was imaged,
estimating a first estimated age of a human figure in a face image for search at an imaging time point of the input image, based on a time point when the face image for search to detect a person was imaged, an age of the human figure in the face image for search at the time point when the face image for search was imaged, and the imaging time point of the input image,
estimating a second estimated age of a human figure imaged in the input image, and
detecting, as an event, a scene where the human figure for which the second estimated age has been estimated, the second estimated age having a difference not smaller than a preset predetermined value to the first estimated age.

10. The image search apparatus of claim 9, wherein the event detection module estimates a time point when the input image was imaged, based on time point information embedded as an image in the input image.

11. The image search apparatus of claim 9, wherein
the event detection module estimates a third estimated age of at least one human figure for which a similarity to the face image for search is not smaller than a preset predetermined value, among human figures imaged in the input image, and
the event detection module estimates a time point when the input image was imaged, based on a time point when the face image for search was imaged, an age of the human figure in the face image for search at the time point when the face image for search was imaged, and the third estimated age.

12. An image search method, comprising:
detecting events from an input image, and determining levels depending on types of the detected events;
retaining the detected events for each of the levels; and
outputting the retained events for each the levels.
